(19) United States
(12) Patent Application Publication
(10) Pub. No.: US 2002/0159026 A1
(43) Pub. Date: Oct. 31, 2002

(54) Optical medium with tailored electromagnetic spectrum transmission

(76) Inventor: Edward A. Bernheim, Corpus Christi, TX (US)

Correspondence Address: G. Turner Moller, 711 N. Carancahua, Suite 720, Corpus Christi, TX, 78475, US

(21) Appl. No.: 09/845,468

(22) Filed: Apr. 30, 2001

(51) Int. Cl. G02C 7/10

(52) U.S. Cl. 351/163

(57) ABSTRACT

Optical media have predetermined regions of the spectrum where transmission is selectively reduced. Preferably, ultraviolet light is substantially prevented from passing through the media. A blue blocker is incorporated into the media, or as a coating on the media, for reducing transmission in the range of 400-540 nanometers. A red blocker is incorporated into the media, or as a coating on the media, for reducing transmission in the range of 625-760 nanometers. An infrared blocker is incorporated into the media, or as a coating on the media, for reducing transmission in the range of 760-1100 nanometers.

### FIELD OF THE INVENTION

This invention relates to eyeglass lenses, windows, wind-screens and other optical media designed to reduce transmission of selected ultraviolet, blue, red and infrared electromagnetic waves.

### BACKGROUND OF THE INVENTION

Eyeglasses are commonly used in our society for the correction of vision, sharpness of vision, and physical protection of the eye, e.g. from harmful radiation or projectiles. For example, sunglasses or other tinted or colored spectacles are worn to protect the eye from intense brightness and from the sun's ultraviolet radiation, or to merely make fashion or aesthetic statements. Similarly, office, residential, and other building windows, laboratory windows, and aircraft, automotive, and other vehicular windows or wind-screens may be coated or impregnated with UV or brightness protective materials or compounds, or tinted or otherwise modified to reduce and eliminate the transmission of electromagnetic waves.

It may be seen in any of these cases that the optimal solution to the problem is providing maximum benefit to the eye. This is done by providing a spectacle lens set, eye glass, or other optical part which permits either uncorrected and undistorted images, or fully vision corrected images, to reach the eye throughout the entire field of vision while simultaneously filtering out undesirable haze, various radiation, physical objects and projectiles.

Many partial solutions have been offered, for example, corrective lenses, sunglasses, glasses adapted for the protection from ultraviolet rays, infrared blocking lenses, blue blocking lenses, and safety glasses have all been known and used for many years. Indeed, some solutions have combined different elements of the full protection idea. For example, safety glasses made of smoked or colored glass have been offered, as have wrap around sunglasses.

Disclosures of some interest relative to this invention are found in U.S. Pat. Nos. 3,400,156; 3,724,934; 3,826,751; 3,850,502; 4,878,748; 4,952,046; 5,157,426; 5,177,509; 5,400,175; 5,402,190; 5,428,474; 5,518,810; 5,592,245; 5,614,963; 5,617,154; 5,838,419 and 5,846,457.

### BRIEF DESCRIPTION OF THE INVENTION

No one has as yet been able to provide in a single lens with optics and full or tailored radiation protection in selected portions of the electromagnetic spectrum, while maintaining all the other properties mentioned above. In particular, no one has yet been able to provide a lens or other optical media of various geometry's or corrective power which at once provides tailored blockage, absorption, or transmission of ultraviolet (UV), infrared (IR), and visible spectrum light waves, while simultaneously improving the visual clarity of the lens and giving heat shielding.

This invention accordingly relates to improved eyeglass lenses, windows, wind-screens, and other varied optical media provided with additives, coatings, and other agents or compounds to tailor absorption, blockage, and transmission of ultraviolet, infrared, and other visible and/or non-visible electromagnetic waves, heat shielding and to improve visual clarity, user comfort, and functionality of the optical media.

The method and apparatus of this invention provide spectacle lenses and other optical media having tailored transmission or blockage of selected proportions and frequencies of the electromagnetic spectrum, including in particular ultraviolet, infrared, and visible radiation and/or light waves, improved visual clarity and heat shielding. In accordance with one embodiment of this invention, the optical media comprises a blue blocker for blocking transmission of at least 80% of electromagnetic energy having a wave length in the range of 400-540 nanometers, a red blocker for at least partially blocking transmission of electromagnetic energy having a wave length in the range of 625-760 nanometers and an infrared blocker for blocking a substantial portion of the energy of a wave length in the range of 760-1100 nanometers.

In accordance with another embodiment of this invention, an optical media comprises a blocker preventing transmission of at least 50% of a predetermined laser frequency and is used in conjunction with a laser emitting the predetermined frequency.

It is an object of this invention to provide an improved optical media.

Another object of this invention is to provide an optical media that reduces transmission of blue frequencies and reduces transmission of red frequencies.

Another object of this invention is to provide an optical media, used in conjunction with a laser, that reduces transmission of the laser frequency.

A further object of this invention is to provide an optical media that substantially eliminates transmission of ultraviolet frequencies, and reduces transmission of blue and red frequencies.

These and other objects and advantages of this invention will become more apparent as this description proceeds, reference being made to the accompanying drawings and appended claims.

### DETAILED DESCRIPTION OF THE INVENTION

These desired results are achieved either through the addition of various selected agents or other compounds to the lens or other optical media as the optical part is being formed by casting, polymerization, extrusion and the like. The agent is either suspended in the primary structural composition of the resin or by the application of a wide variety of coatings. Coatings useful to this invention may be comprised a number of pure and/or mixed vacuum deposited metals, vacuum deposited non-metals, vacuum deposited organometallics or dielectric materials.

The lens may be coated in any suitable manner, for example, by vapor deposition or by plasma coating. The lenses may also be polarized, either by applying a polarizing film, coating, or some other method. Films and coatings according to this invention may be applied to either the inside or the outside surface of the lens. It can also be applied between the layers of a laminate. It can also be applied to any combination of the above, depending on the exact nature of the lens, the coating, and the intended purpose. A surface coating may be produced in any suitable manner, as is well known in the art, i.e. by air drying, oven curing or drying, UV curing or electron beam curing. These coatings may contain dyes and other additives to modify the ultraviolet, infrared, and visible radiation and/or light waves.

The precise level of absorption or reflection of various radiation levels may be selected and customized according to need. For example, in one embodiment, in the visual spectrum, specified wavelengths may be selectively blocked, while substantial or complete protection for IR and UV radiation is achieved.

The use of coating, films, and laminates according to the invention permits a target lens to be of arbitrary shape, to accommodate an unlimited number of applications. Thus lenses and optical forms according to the invention may use high-base curve decentered optics, toric base curves, spherical base curves, cylindrical base curves, or any other lens geometry. The system is applicable also to architectural windows, windshields, helmets, etc.

The invention provides an optical medium, or a combination of optical media, provided with one or more coatings or inclusions to selectively permit desired levels and bandwidths of UV, IR and visible spectrum radiation to pass through the lens.

In a particularly important aspect, the invention provides optical media adapted for luminous transmittance (weighted calculation between 380 nanometers and 760 nanometers) between 8% to 100% in applications covered by American National Standard ANSI Z80.3-1996. For all other applications the inventions luminous transmission range (weighted calculation between 380 nanometers and 760 nanometers) is 4% to 100%. Ultraviolet light should be blocked at least to 75%, and preferably to at least 95%, between 0-400 nanometers (hereinafter nm.). Infrared light and radiation blockage should be at least 50% and preferably be 70-100% on calculated average between 760-1100 nm. Visible red light preferably should be at least 10% blocked between 625-760 nm. and preferably 25-90% blocked. Blue light is considered to include electromagnetic radiation in the 400 nm. to 540 nm. range, but sharpened clarity also occurs with blocking from 400 nm.-500 nm. In one embodiment of this invention, at least 80% of blue light in the range of 400-500 nm. is blocked. Preferably, at least 80% of blue light in the range of 400-540 nm. is blocked and, most desirably, at least 95% of radiation in the range of 400-540 nm. is blocked.

Such media are provided by introducing dyes and other agents or compounds which absorb infrared radiation to the basic component, either by adding the agents to the resin before lens formation, and thereby providing solution, dispersion, suspension, or chemical bonding of the agents to the resin, or by coating one or more surfaces of a molded, cast, extruded, or in some way formed part with an agent or coated with the agent dispersed, solubilized, or suspending in a resinous coating system. In this invention, an optical medium may be prepared by adding any one of a number of infrared absorbing agents to a polycarbonate (PC) resin available from General Electric Corporation, or to the polymer available commercially from Pittsburgh Plate Glass under the name CR-39, or any other known moldable lens material, as for example polymerized and polymerizable methyl methacrylate, and the resulting composition is cast or molded as a lens or other optical medium. Alternatively, such compounds may be applied as a coating to a cast or formed or molded medium, through any of a variety of known processes, including vacuum deposition, dielectric processes, with the agent dispersed, solubilized, or by plasma methods involving introduction of coatings as gases to a vacuum in a highly charged electric atmosphere and thereafter depositing them on the part. The process may also use resinous coatings that are applied to either side of the part.

An example of an IR-absorbent compound particularly suited for addition to the various systems mentioned above is any of the dyes available under the tradename KEYSORB from Keystone Aniline and Dye Corporation, of Chicago, Ill. Another example of laser blocking dye are those available from H. W. Sands Corp. of Jupiter, Fla. These dyes block very specific wavelengths of the infrared range.

Satisfactory results have also been achieved by adding such dyes to compounds commonly used as lens coatings, and particularly as a hard protective lens coatings, and thereafter coating the optical medium according to various processes, many of which are well known in the art. An example of a coating to which such dyes may be added in embodiments of the invention to which IR-absorbent agents are added to make coating is Exxene Hardcoat PST-1, or other polysiloxane-based coatings. Red visible light must be blocked 10-100% between 625 nm. and 760 nm.

A particularly useful application of this aspect of the invention is to provide protective eyewear and other optical media adapted for the blockage of selected portions of the electromagnetic spectrum, both visible and infrared associated with the output of lasers. Lasers can cause tremendous damage to the human eye and these lenses can use dyes and other additives to block the visible and infrared ranges appropriately. Specifically, in accordance with this embodiment of the invention, eyewear is made that blocks at least 50% of the laser frequency. Such eyewear is worn by persons working in the vicinity or range of the laser. The blockage is sufficient to provide substantial protection to the wearer and the transmittance is sufficient to alert the user of the existence and direction of the laser.

Lasers produce visible light that allows a person to see the laser and also produces an infrared frequency that cannot be seen. A typical argon laser is visible at 514 nm. and the IR radiation is at 887 nm. To block, or partially block, the laser frequencies, an optical media must provide a first component to obstruct transmission of the visible frequency and a second component to obstruct transmission of the infrared frequency. To block the visible frequency, one or more commercially available dyes may be used. In the case of an argon laser visible at 514 nm., a mixture of dyes commercially available as Orient Valifast 4120, Spectrum 125 and Orient Valifast 3209, available from Orient Chemical Company of Port Newark, N.J. is satisfactory. A suitable dye to block the infrared frequency at 887 nm. is Keystone Keysorb 910, available from Keystone Aniline and Dye Corporation, of Chicago, Ill. Thus, a person working in the vicinity of a laser wearing glasses or goggles of this invention is protected from eye damage caused by the laser.

Another aspect of the invention provides an optical medium adapted for complete blockage or partial blockage of the ultraviolet radiation in the ultraviolet region of the electromagnetic spectrum. Most typically UV radiation is considered to include electromagnetic radiation in the 0 nm. to 400 nm. range. Such media are provided by introducing agents, many well known within the industry, to the basic resin, either by adding the agents to the resin during lens or part manufacture, and thereby providing for dispersion, solution, suspension, or chemical bonding of the agents with the base resin, or by coating one or more surfaces of the part with the agent. In one embodiment of this, invention is the making of optical parts to this aspect of the invention any one of a number of UV absorbing agents are added to polycarbonate (PC) resin, or to the polymer available commercially under the name CR-39, or any other known moldable lens material, as for example polymerized and polymerizable methyl methacrylate, and the resulting composition is cast or molded as a lens or other optical medium. Alternatively, such compounds may be applied as a coating to a cast or formed or molded medium, through any of a variety of known processes, including vacuum deposition, dielectric processes, with the agent dispersed, solubilized, or suspending in a resinous coating system, or by plasma methods involving introduction of coatings as gases to a vacuum in a highly charged electric atmosphere and thereafter depositing them on the part. The process may also use resinous coatings that are applied to either side of the part. Typical UV absorbing additives and materials are available from BASF under the names Uvinul D-50 and Uvinul N-539. Satisfactory results have also been achieved by adding such dyes to compounds commonly used as lens coatings, and particularly as a hard protective lens coatings, and thereafter coating the optical medium according to various processes, many of which are well known in the art.

Another aspect of the invention provides an optical medium adapted for transmission of selected levels or complete blockage of radiation in the blue portion of the visible electromagnetic spectrum. Most typically blue radiation is considered to include electromagnetic radiation in the 400 nm. to 540 nm. range, but sharpened clarity also occurs with blocking from 400 nm.-500 nm. and ranges in between. Such media are provided by introducing agents, many well known within the industry, to the basic resin, either by adding the agents to the resin during lens or part manufacture, and thereby providing for dispersion, solution, suspension, or chemical bonding of the agents with the base resin, or by coating one or more surfaces of the part with the agent. In one embodiment of this invention is the making of an optical part using any one of a number of yellow, red, orange, brown, or other blue-absorbing dyes or other agent of good media solubility are added to polycarbonate (PC) resin, or to the polymer available commercially under the tradename CR-39, or any other known moldable lens material, as for example polymerized and polymerizable methyl methacrylate, and the resulting composition is cast or molded as a lens or other optical medium. Alternatively, such compounds may be applied as a coating to a cast or formed or molded medium, through any of a variety of known processes, including vacuum deposition, dielectric processes, with the agent dispersed, solubilized, or suspending in a resinous coating system, or by plasma methods involving introduction of coatings as gasses to a vacuum in a highly charged electric atmosphere and thereafter depositing them on the part. The process may also use resinous coatings that are applied to either side of the part. Dyes suitable for use in this aspect of the invention comprise any of the dyes known in the art which are compliments of those portions of the blue band of the spectrum which are to be blocked or absorbed or block by the part and are media compatible. While many of the dyes suitable for use with this aspect are useful in this application many must be tightly concentration controlled. If it is not, a problem is caused since the parts will be used for lenses, windows, etc., through which people will wish to look or to observe colored objects. To see these colored object correctly 2% or 3% of the blue band radiation must pass through the lens, to aid in color differentiation. Some visual clarity effects occur with as much as 10% blue transmittance. Examples of dyes suitable for use suitable with this aspect of the invention include Orient Valifast 4122 (yellow), Spectrum 125 (red), Orient Valifast 3209 (Orange) or any number of browns. Satisfactory results have also been achieved by adding such dyes to compounds commonly used as lens coatings, and particularly as a hard protective lens coatings, and thereafter coating the optical medium according to various processes, many of which are well known in the art.

The resultant media are opaque, to a greater or lesser and selectable degree, to blue band radiation, and may be freely used with media adapted for transmission of select infrared levels and bandwidths of other portions of the electromagnetic spectrum according to the disclosure herein.

Another aspect of the invention provides an optical medium adapted for transmission of selected levels or complete blockage of radiation in the red portion of the visible electromagnetic spectrum. Most typically red radiation is considered to include electromagnetic radiation in the 625 nm. to 760 nm. range. Such media are provided by introducing agents, many well known within the industry, to the basic resin, either by adding the agents to the resin during lens or part manufacture, and thereby providing for dispersion, solution, suspension, or chemical bonding of the agents with the base resin, or by coating one or more surfaces of the part with the agent. Rather than use a separate dye for blocking the red portion of the spectrum, and thereby increase manufacturing costs, it is much preferred to select an infrared blocker that has a sufficiently wide effective range to block portions of the visible red spectrum. Suitable infrared blockers that also effectively block visible red frequencies are available under the tradename KEYSORB from Keystone Aniline and Dye Corporation, of Chicago, Ill.

There are many variations of this invention. While the invention may block UV, some amount of IR, some amount of visible light, and some amount of blue light, there are many variations. This is accomplished through the use of multiple media layers, each tailored for the control of a given band of radiation and thereafter combined to form a single medium, or by co-molding, forming, or multiple coating layers.

Lenses can be prepared out of many materials: 1. polycarbonate 2. CR-39 3. Safety glass or other suitable optical material.

UV light: 4. complete blocking

IR radiation: 5. complete blocking 6. partial blocking

Blue Light: 7. block all blue light 8. Let some blue light through for color accuracy photochromic properties

9. Use of an orange, yellow, and/or red photochromic dye layer to have the blue blocking vary from indoor to outdoors. An example is Color Change Orange 3.

A photochromic dye may be incorporated into an optical media to cause the coating to darken and lighten with sun brightness. An example is John Robinson Oxford Blue Photochromic Additional coloring for aesthetic or stylistic purposes. 11. Yes 12. No

Surface coating: 13. Hard coating 14. Anti-fog coating 15. Optical anti-static coating 16. Other coating 17. No coating

Examples of possible combinations:

A preferred sunglass would be 1, 4, 6, 8, 10, 11, 13

A suitable prescription sunglass would be 2, 4, 6, 8, 12, 17

A safety glass safety lens would be 3, 4, 5, 8, 12, 14,

A hunting and fishing lens would be 1, 4, 6, 8, 9, 11, 13 on the outside surface, 14 on the inside surface

Architectural smoked window glazing: 1, 4, 6, 7, 12, 13

Many additional combinations are possible.

Many types of media according to the invention may be advantageously adapted, by mean and methods known within the art. Media according to the invention may be used in combination with materials having photochromic properties. Also there is good compatibility with the use of specialty coating, color manipulation, and hydrophobic agents.

A particular advantageous aspect of the invention is that the optical media according to the invention may be adapted to permit any desired proportion of visible electromagnetic radiation to be transmitted by the media. For example, in the making of sunglasses it has been found to be beneficial to provide a lens which permits at least 8% and preferably about 10% of visible light to pass through the lens.

Applications suitable for optical media according to the invention include building and vehicular windows and wind screens, aquatic windshields, eyeglasses, and any other media through which the monitoring or use of transmitted electromagnetic radiation is desired. The system is also useful in applications where heat blocking or insulation from IR. light is required.

### EXAMPLE 1

A mixture is made out of 58.9% Exxene PST-1, 20% Acetone, 10% Isobutyl Alcohol, 10% Diacetone Alcohol, 0.34% Orient Valifast 4122, 0.012% Spectrum 125, 0.15% Orient Valifast 3209, 0.6% Keystone Keyplast 910, is mixed for one hour and filtered through a one micron filter. A polycarbonate piano lens with UV Blocker and Grey dye is dip coated in the above batch with phased withdrawal of 3.3 mm./sec. The part is allowed to stand for 5 minutes and then baked at 120° C. for 40 minutes. The resultant data is as follows: UV blocking (0-400 nm.)—100%; IR blocking (760-1100 nm.)=94.6%; blue blocking (400-500 nm.)=98.5%; luminous transmittance per ANSI 80.3 (1996)=8.9%; red visible light blocking (625-760 nm.)—81%. The resultant color is a greenish brown.

### EXAMPLE 2

It was desired to provide a lens giving full protection from UV rays, no more than 15% transmission of IR radiation, 0.3% to 1.0% blue spectrum transmission, and total visible light transmission of 7%-15%. The lens was coated dielectrically with titanium dioxide and then coated with the solution of Example 1.

### EXAMPLE 3

A typical argon laser is visible at 514 nm. and has IR radiation at 887 nm. A batch is made of 58.3% Exxene S-24-20, 20% acetone, 10% isobutanol, 0.29% Orient Valifast 4120, 0.011% Spectrum 125, 0.14%, Orient Valifast 3209, and 1.2% Keystone Keysorb 910. The batch is mixed for one hour and filtered through a one micron filter. A polycarbonate plano lens with UV blocker and grey dye is dip coated in the mixture with phased withdrawal of 3.7 mm/sec. The lens is allowed to stand five minutes and then is baked at 100° Centigrade for one hour. The resultant data is: UV blocking (0-400 nm.)—100%; IR blocking (760-1100 nm.)—99.1%; blue blocking (400-500 nm.)—97.6%; luminous transmittance per ANSI 80.3 (1996)—5.9%; red visible light blocking (625-760 nm.)—29%. The resulting color is green. The laser frequency at 514 nm. is blocked in excess of 95%.

In the foregoing description, the method and apparatus of the present invention have been described with reference to a number of examples that are not to be considered limiting. Rather, it is to be understood and expected that variations in the principles of the method and apparatus herein disclosed may be made by one skilled in the art and it is intended that such modification, changes, and/or substitutions are to be included within the scope of the present invention as set forth in the appended claims. The specification is accordingly to be regarded in an illustrative rather than in a restrictive sense.

I claim:

1. A light transmitting optical part comprising a blue blocker for blocking transmission of at least 80% of electromagnetic energy having a wave length in the range of 400-500 nanometers, a red blocker for blocking transmission of at least 10% of electromagnetic energy having a wave length in the range of 625-760 nanometers and an infrared blocker for blocking transmission of at least 50% of electromagnetic energy having a wave length in the range of 760-1100 nanometers.

2. The light transmitting optical part of claim 1 further comprising an ultraviolet blocker for blocking transmission of at least 95% of electromagnetic energy having a wave length of 0-400 nanometers.

3. The light transmitting optical part of claim 1 wherein the blue blocker blocks transmission of at least 80% of electromagnetic energy having a wave length in the range of 400-540 nanometers.

4. The light transmitting optical part of claim 1 wherein the luminous transmittance of visible light is in the range of 4-100%.

5. The light transmitting optical part of claim 4 wherein the luminous transmittance of visible light is at least 8%.

6. The light transmitting optical part of claim 1 wherein the red blocker blocks transmission of at least 70% of electromagnetic energy having a wave length in the range of 625-760 nanometers.

7. The light transmitting optical part of claim 1 wherein the infrared blocker and the red blocker is a dye having the capability of blocking both infrared and visible red frequencies.

8. In combination, a laser emitting electromagnetic energy at a predetermined frequency and a light transmitting optical part within range and sight of the laser comprising a blocker preventing transmission of at least 50% of the predetermined frequency.

9. The combination of claim 8 wherein the laser emits a first frequency in the visible spectrum and a second frequency in the infrared frequency and the optical part blocks at least 50% of the first frequency and 50% of the second frequency.

10. A method of using a laser emitting electromagnetic energy at a predetermined frequency comprising
providing a light transmitting optical part for a worker adjacent the laser, the optical part having a blocker preventing transmission of at least 50% of the predetermined frequency; and
placing the optical part in front of at least one of the worker's eyes.

11. The method of claim 10 wherein the laser emits a first frequency in the visible spectrum and a second frequency in the infrared spectrum and the optical part provides a blocker preventing transmission of at least 50% of the first frequency and 50% of the second frequency.
